(19) United States
(12) Patent Application Publication
(10) Pub. No.: US 2007/0227278 A1
(43) Pub. Date: Oct. 4, 2007

(54) CLEARANCE ADJUSTABLE WIPER

(76) Inventors: Chien-Wei Tsou, Taichung (TW); Yu-Fang Yen, Taichung (TW)

Correspondence Address: BANGER SHIA, 204 CANYON CREEK, VICTORIA, TX, 77901, US

(21) Appl. No.: 11/277,753

(22) Filed: Mar. 28, 2006

(51) Int. Cl. F16H 27/02

(52) U.S. Cl. 74/89.4

(57) ABSTRACT

A wiper is disposed in the annular groove at either end of the nut, and the wiper is in the form of a flexible ring slightly larger than the annular groove of the nut. An annular conical surface inclined toward the annular groove is formed on the wiper for mating with the outer edge of the nut. A helical wiping portion is formed in the inner surface of each of the wiper for engaging in the screw shaft, and a plurality of slots penetrating the helical wiping portion are formed in the annular conical surface. The design of the slots not only can reduce the wiping resistance but also facilitate the discharge of foreign bodies. The wiping clearance between the helical wiping portion of the wiper and the helical groove of the nut can be adjusted by rotating or reversely rotating the wiper relative to the nut.

### BACKGROUND OF THE INVENTION

1. Field of the Invention

The present invention relates to a ball screw, and more particularly to a clearance adjustable wiper disposed at either end of the nut of a ball screw, the wiper is simply structured, it can reduce the wiping resistance, prevent the invasion of foreign bodies and can adjust the wiping clearance between the wiper and the screw shaft.

2. Description of the Prior Art

Since linear transmission products are being applied more and more widely in the modern industry, various linear transmission mechanisms have widely come into human life, manufacturing factory and high science and technology instruments, such as linear guideway, ball screw, and the like. Particularly in a large-scale precision mechanism are usually installed various large and small ball screws or linear guideway systems. Although the technology for linear transmission element is developing fast, consumers still need the technology to be improved uninterruptedly. Therefore, there are still some problems to be solved. And this desire for constant improvement of technology is particular strong in many high precision mechanism-manufacturing fields (such as wafer process equipment, CNC equipment, etc) that require comparative stability and quiet. Hence, the existing linear mechanism still has some technological blind spots to be improved.

A conventional ball screw commonly seen on the market is shown in FIG. 1, a wiper 11 is inserted and fixed in either end of a nut 12 of the screw shaft 10 by screws, and the wiper 11 uses its flange 111 to prevent invasion of foreign bodies and loss of lubricant. However, in order to compensate the manufacturing error, it has to leave a clearance (approximately 0.25 mm) between the flange 111 of the conventional wiper 11 and the helical groove 101 of the screw shaft 10, and the manufacturing error will increase the clearance. According to the known knowledge in the art that it will cause damage to the ball screw if the foreign body is larger than 0.17 mm, therefore, the conventional clearance (approximately 0.25 mm) will have the problems of invasion of foreign bodies and loss of lubricant.

If want to have a better wiping effect, the clearance cannot be reserved between the flange 111 of the conventional wiper 11 and the helical groove 101 of the screw shaft 10. However, this method also has its disadvantage that the flange 111 of the wiper 11 will press overtightly against the helical groove 101 of the screw shaft 10. This will not only lead to a considerable increase of the friction force, substantial decrease of the mechanical efficiency, but also will result in a great number of foreign bodies accumulated between the wiper 11 and the helical groove 101, causing many more problems.

Because of the abovementioned reasons, another two types of improved linear ball screws were developed and appeared on the market, which are explained as follows:

A, a ball screw disclosed by U.S. Pat. No. 6,571,653 B1 is shown in FIG. 2, likewise, the wiper 13 also uses a flange 131 to prevent invasion of foreign bodies and loss of lubricant. And a spring coil 14 is arranged at the end of the flange 131 for increasing the radial force thereat, and a plurality of grooves having one end closed are formed in the flange 131 for reducing friction force. However, the design of the grooves 131 having one end closed will enable the foreign bodies to be accumulated quickly to fill up the grooves 132 (in the feeding direction) during rotation, and the foreign bodies will be accumulated on the screw shaft permanently. As a result, the mechanical efficiency of the ball screw will be largely reduced, and the spring will also become loose and fatigued easily after abrasion, resulting in an unstable stopping effect.

B. Another conventional type product is shown in FIG. 3, in which, an annular brush 17 is positioned in the nut 15 by a C-shaped ring 16, the annular brush 17 is used as a wiper and no clearance is necessarily reserved. Although the annular brush 17 is free of the friction caused by overly tight contact, it still can't completely prevent the invasion of foreign bodies. After a long period of use, foreign bodies still will be accumulated between the nut 15 and the screw shaft 18, causing a great number of lubricant loss and an unstable operation.

It can be learned from the abovementioned products that the clearance problem in the use of the conventional wiper is always the key problem that the manufacturers most want to improve. The clearance must be adjusted, cleaned and maintained regularly, otherwise an overlarge or an overly small clearance all will affect the operation of a ball screw.

To solve the aforementioned problems, the inventor of this invention, on the basis of the accumulated experience and skills associated with the linear transmission field, develops a clearance adjustable wiper for a ball screw, which uses its simple structure to reduce the wiping resistance, and it can prevent invasion of foreign bodies and loss of lubricant.

### SUMMARY OF THE INVENTION

The primary objective of the present invention is to provide a clearance adjustable wiper.

The wiper is in the form of a flexible ring slightly larger than the annular groove of the nut. An annular conical surface inclined toward the annular groove is formed on the wiper for mating with the outer edge of the nut. A helical wiping portion is formed in the inner surface of each of the wiper for engaging in the screw shaft, and a plurality of slots penetrating the helical wiping portion are formed in the annular conical surface. The wiping clearance between the helical wiping portion of the wiper and the helical groove of the nut can be adjusted by rotating or reversely rotating the wiper relative to the nut.

The secondary objective of the present invention is to provide a clearance adjustable wiper that has low wiping resistance and can effectively expel the foreign bodies.

The plurality of slots penetrating the helical wiping portion are formed in the annular conical surface so as to reduce the wiping resistance of the wiper, and the slots are inclined in the rotating direction of the ball screw, thus it can effectively prevent the foreign bodies from being accumulated in the slots.

The present invention will become more obvious from the following description when taken in connection with the accompanying drawings, which show, for purpose of illustrations only, the preferred embodiments in accordance with the present invention.

### BRIEF DESCRIPTION OF THE DRAWINGS

FIG. 1 is a cross sectional view of a conventional ball screw with wiping device;

FIG. 2 is a cross sectional view of another conventional ball screw with wiping device;

FIG. 3 is a cross sectional view of a third conventional ball screw with wiping device;

FIG. 4 is a perspective view of a wiper in accordance with the present invention;

FIG. 5 is a side view of the wiper in accordance with the present invention;

FIG. 6 is an assembly cross sectional view of the wiper in accordance with the present invention;

FIG. 7 is an enlarged cross sectional view of showing the wiping of the present invention being mounted on the screw shaft together with the nut;

FIG. 8 is a cross sectional view of showing a design of the annular groove of the nut in accordance with the present invention;

FIG. 9 is a cross sectional view of showing another design of the annular groove of the nut in accordance with the present invention; and

FIG. 10 is a cross sectional view of showing another design of the annular groove of the nut in accordance with the present invention.

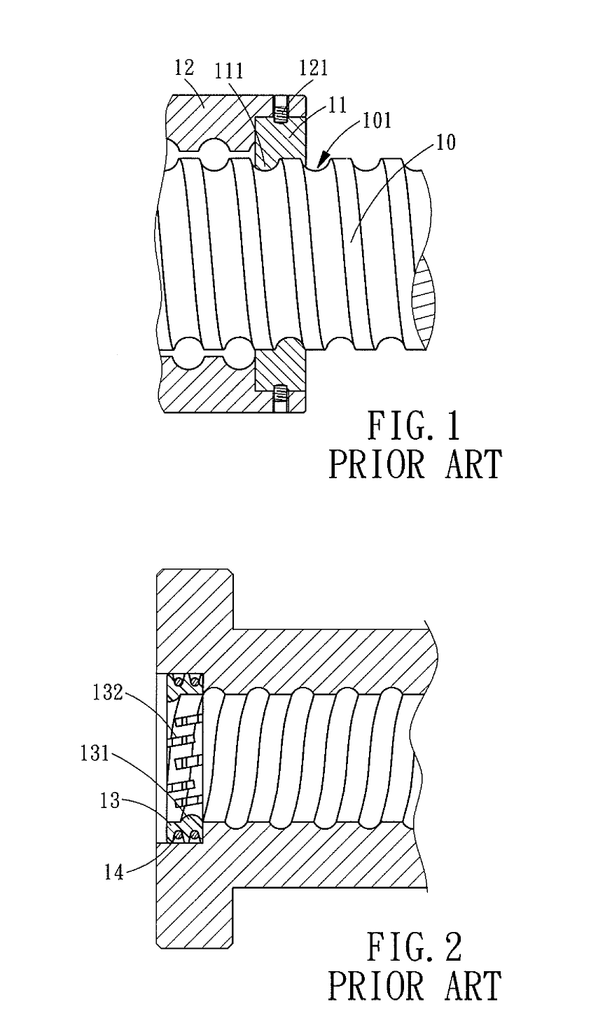

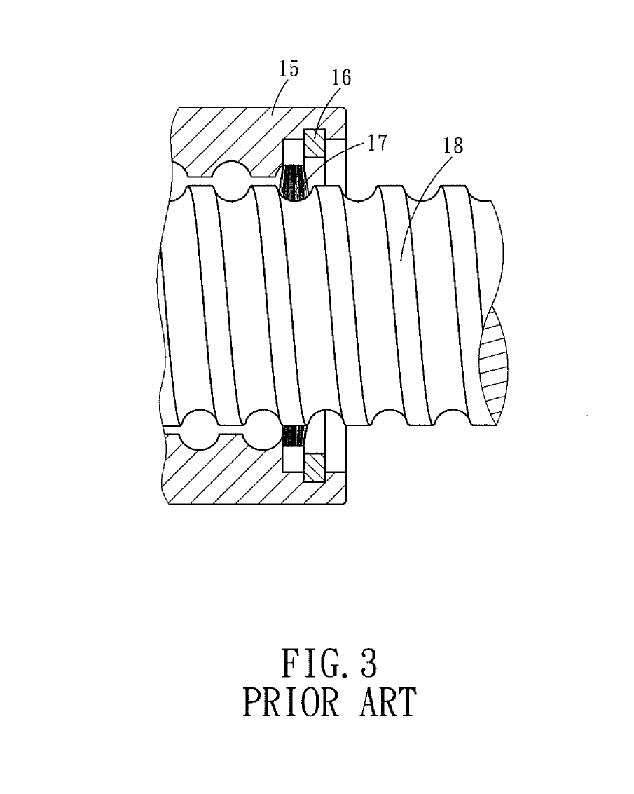

### DETAILED DESCRIPTION OF THE PREFERRED EMBODIMENTS

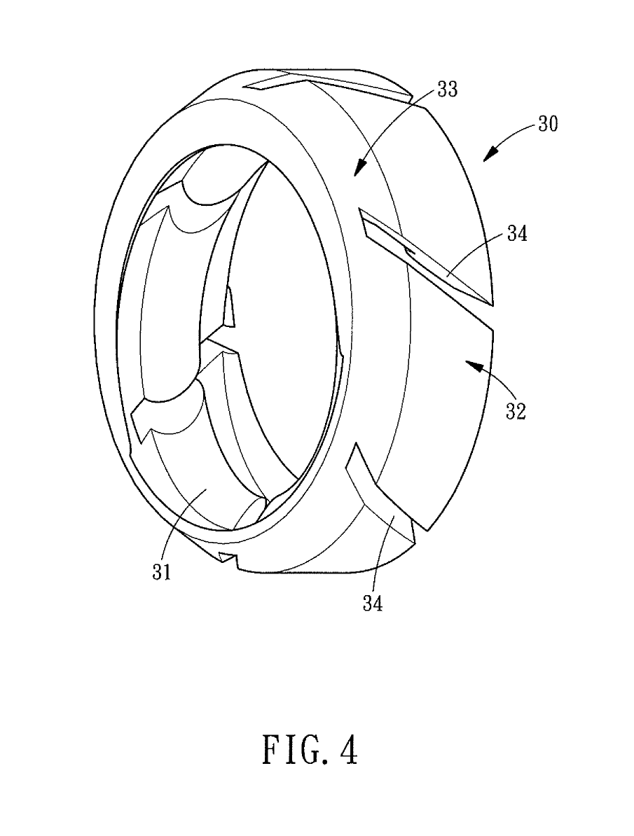

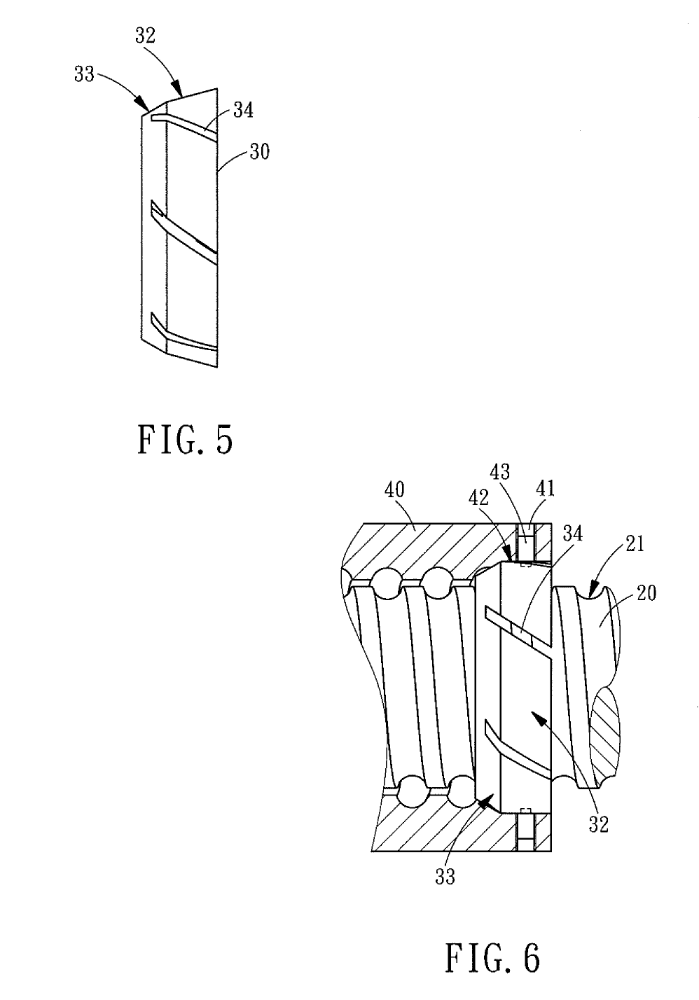

The foregoing, and additional objects, features and advantages of the present invention will become apparent from the following detailed description of preferred embodiment thereof, taken in conjunction with the accompanying FIGS. 4-7.

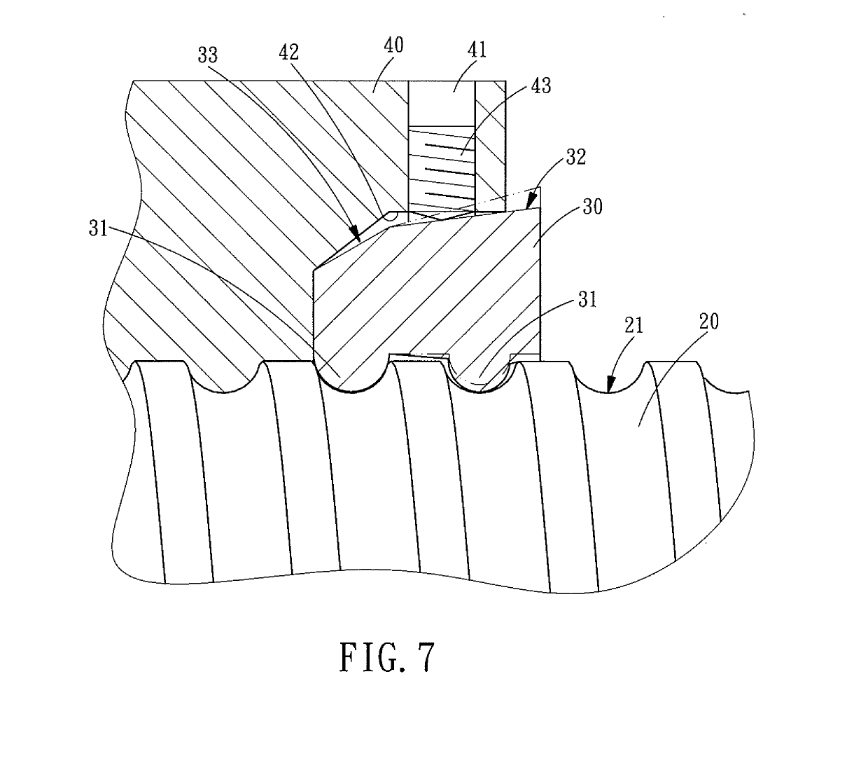

Two clearance adjustable wipers 30 in accordance with the present invention are mounted on a screw shaft 20 of a ball screw by a nut 40, and the structure of the wipers is described as follows (the structure of the nut and the screw shaft is shown in FIGS. 6 and 7).

The screw shaft 20 is formed on its outer surface with a helical groove 21.

Two wipers 30 are annular structures mounted onto the screw shaft 20. A helical wiping portion 31 is formed on the inner surface of each of the wipers 30 for engaging with the helical groove 21 of the screw shaft 20, and the clearance between the helical wiping portion 31 and the helical groove 21 gradually increases in size from inside toward outside (that is: several circles of helical wiping portion 31 decreases in size from inner circles toward outer circles). An annular conical surface 32 is formed on the outer periphery of the wipers 30 and is inclined toward the annular groove of the nut, and formed at a side of the annular conical surface 32 is a conical guiding surface 33. A plurality of slots 34 are formed in the annular conical surface 32 and penetrate the helical wiping portion 31, and the slots 34 are inclined in the direction of the helical groove 21 of the screw shaft 20.

The nut 40 is mounted on the screw shaft 20, and an annular groove 42 is formed in the inner periphery of either end of the nut 40 for mating with the annular conical surface 32 of the wipers 30. The inner diameter of the annular groove 42 is smaller than the maximum outer diameter of the respective wipers 30, and the annular conical surface 32 of each of the wipers 30 is engaged in the annular groove 42. The slots 34 will make the wipers 30 shrink inward, causing a radial deformation. A radial positioning hole 41 is formed in the nut 40, and a screw 43 is screwed through the radial positioning hole 41 and into the annular conical surface 32 of the wipers 30 for fixing the wipers 30 (the radial deformation of the wipers is also fixed), and the wiping clearance between the helical wiping portion 31 and the helical groove 20 can be adjusted to a desired extent.

For a better understanding of the embodiment, its operation and function, reference should be made to the below description.

To decrease the wiping clearance:

The wipers 30 are positioned in the nut 40 in such a manner that the helical wiping portion 31 is engaged in the helical groove 21 of the screw shaft 20. When the wipers 30 start to rotate with respect to the nut 40, the annular conical surface 32 of the respective wipers 30 is engaged in the annular groove 42, during rotation, the slots 34 will make the wipers 30 shrink inward, causing a radial deformation. And the originally reserved clearance between the helical wiping portion 31 and the helical groove 21 will gradually increase in size from inside toward outside. However, the radial deformation of the wipers 30 will enable the respective circles of helical wiping portion 31 to maintain an equal clearance with respect to the helical groove 21 (the farther outside the wiping portion 31 is located, the greater the amount of inward shrinkage will be). In this way, the wiping clearance can be reduced. And after that, the wipers 30 can be fixed by the screw 43 inserted in the positioning hole 41 of the nut 40.

To increase the wiping clearance:

The user can loosen the screw 43 of the nut 40 (to release the wipers 30), and then reversely rotate the wipers 30 relative to the nut 40. The annular conical surface 32 of the wipers 30 will gradually move out of the annular groove 42. During rotation, the slots 34 will make the wipers 30 expand inward, causing a radial deformation. The originally reserved clearance between the helical wiping portion 31 and the helical groove 21 will expand outward. Therefore, the wiping clearance can be increased as desired at any time. And finally, the wipers 30 can be fixed by the screw 43 inserted in the positioning hole 41 of the nut 40.

In addition, since the slots 34 are formed in the annular conical surface 32 and penetrate the helical wiping portion 31, and are inclined in the direction of the helical groove 21 of the screw shaft 20, when the wipers 30 are wiping foreign bodies with the wiping portion 31, the foreign bodies will be expelled via the inclined slots 34 (the inclined angle can be designed based on the rotating direction for facilitating the expelling of foreign bodies). Therefore, the present invention doesn't have the problem of foreign bodies accumulation.

It will be noted that the conical guiding surface 33 is formed at a side of the annular conical surface 32 of the wipers 30 and located in the helical groove of the screw shaft, and the conical guiding surface 33 is designed based on the condition that the inner diameter of the annular groove 42 is smaller than the maximum outer diameter of the respective wipers 30. And the conical guiding surface 33 facilitates the user to push the wipers 30 into the annular groove 42 of the nut 40, thus effectively reducing the complexity of assembly.

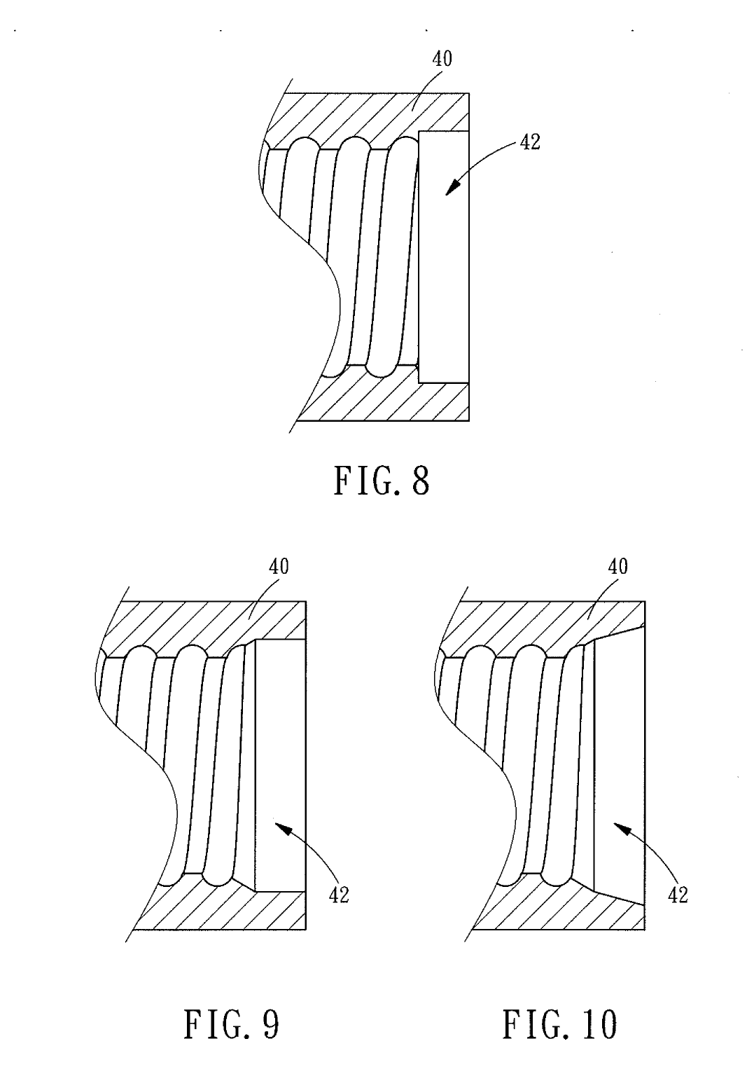

Referring finally to FIGS. 8, 9 and 10, the design of the annular groove 42 of the nut 40 is diversified, it can be a straight groove as shown in FIG. 8, or a combination of a straight groove and a taper, as shown in FIG. 9, or can be a double taper, as shown in FIG. 10. All these forms of annular grooves 42 can produce the aforementioned function by cooperating with the annular conical surface of the wiper. Therefore, the annular groove 42 of the nut 40 can be varied (in terms of shape or taper) according to needs, so as to provide different forms of wiping clearance.

To summarize, the innovated design of the present invention is a wiper disposed in the annular groove at either end of the nut. The wiper is in the form of a flexible ring slightly larger than the annular groove of the nut. An annular conical surface inclined toward the annular groove is formed on the wiper for mating with the outer edge of the nut. A helical wiping portion is formed in the inner surface of each of the wiper for engaging in the screw shaft, and a plurality of slots penetrating the helical wiping portion are formed in the annular conical surface. The design of the slots not only can reduce the wiping resistance but also facilitate the discharge of foreign bodies. The wiping clearance between the helical wiping portion of the wiper and the helical groove of the nut can be adjusted by rotating or reversely rotating the wiper relative to the nut.

While we have shown and described various embodiments in accordance with the present invention, it should be clear to those skilled in the art that further embodiments may be made without departing from the scope of the present invention.

What is claimed is:

1. A clearance adjustable wiper being disposed between a nut and a screw shaft of a ball screw and engaged in an annular groove in an inner periphery of either end of the nut, characterized in that:
the wiper is a flexible ring-shaped structure whose outer diameter is slightly larger than the diameter of the annular groove of the nut, a helical wiping portion is formed in an inner surface of the wiper for engaging in the screw shaft, an annular conical surface is formed on an outer periphery of the wiper and is inclined toward the annular groove of the nut, and a plurality of slots penetrating the helical wiping portion are formed in the annular conical surface.

2. The clearance adjustable wiper as claimed in claim 1, wherein the helical wiping portion is formed in the inner surface of the wiper engaging with a helical groove of the screw shaft, and the helical wiping portion gradually decreases in size from inside toward outside, as a result, a clearance reserved between the helical wiping portion and the helical groove gradually increases in size from inside toward outside.

3. The clearance adjustable wiper as claimed in claim 1, wherein a conical guiding surface is formed at a side of the annular conical surface of the wiper and located in the helical groove of the screw shaft.

4. The clearance adjustable wiper as claimed in claim 2, wherein a conical guiding surface is formed at a side of the annular conical surface of the wiper and is located in the helical groove of the screw shaft.

5. The clearance adjustable wiper as claimed in claim 1, wherein a radial positioning hole is formed in the nut, and a screw is screwed through the radial positioning hole to fix the wiper.

6. The clearance adjustable wiper as claimed in claim 2, wherein a radial positioning hole is formed in the nut, and a screw is screwed through the radial positioning hole to fix the wiper.

7. The clearance adjustable wiper as claimed in claim 3, wherein a radial positioning hole is formed in the nut, and a screw is screwed through the radial positioning hole to fix the wiper.

8. The clearance adjustable wiper as claimed in claim 4, wherein a radial positioning hole is formed in the nut, and a screw is screwed through the radial positioning hole to fix the wiper.

9. The clearance adjustable wiper as claimed in claim 1, wherein the annular groove of the nut is in the form a straight groove, or a combination of a straight groove and a taper, or a double taper, all these forms of annular grooves can provide a clearance-adjustment function by cooperating with the annular conical surface of the wiper.

10. The clearance adjustable wiper as claimed in claim 2, wherein the annular groove of the nut is in the form a straight groove, or a combination of a straight groove and a taper, or a double taper, all these forms of annular grooves can provide a clearance-adjustment function by cooperating with the annular conical surface of the wiper.

11. The clearance adjustable wiper as claimed in claim 7, wherein the annular groove of the nut is in the form a straight groove, or a combination of a straight groove and a taper, or a double taper, all these forms of annular grooves can provide a clearance-adjustment function by cooperating with the annular conical surface of the wiper.

12. The clearance adjustable wiper as claimed in claim 8, wherein the annular groove of the nut is in the form a straight groove, or a combination of a straight groove and a taper, or a double taper, all these forms of annular grooves can provide a clearance-adjustment function by cooperating with the annular conical surface of the wiper.

13. The clearance adjustable wiper as claimed in claim 1, wherein the slots are inclined in the direction of the helical groove of the screw shaft.

14. The clearance adjustable wiper as claimed in claim 2, wherein the slots are inclined in the direction of the helical groove of the screw shaft.

15. The clearance adjustable wiper as claimed in claim 7, wherein the slots are inclined in the direction of the helical groove of the screw shaft.

16. The clearance adjustable wiper as claimed in claim 8, wherein the slots are inclined in the direction of the helical groove of the screw shaft.
